(19) United States
(12) Patent Application Publication
(10) Pub. No.: US 2026/0057194 A1
(43) Pub. Date: Feb. 26, 2026

(54) Natural Language Translation of Database Metadata

(71) Applicant: FMR LLC, Boston, MA (US)

(72) Inventor: Robert C. Davenport, Brookline, MA (US)

(21) Appl. No.: 18/815,299

(22) Filed: Aug. 26, 2024

(51) Int. Cl. G06F 40/58; G06F 16/21; G06F 40/242

(52) U.S. Cl. CPC G06F 40/58; G06F 16/212; G06F 40/242

(57) ABSTRACT

A computerized method is provided for using large language models to integrate data from multiple sources including technical metadata (e.g. column and table names) with a dictionary of standard abbreviations employed in the metadata, representative data from the columns rows of the table, a business glossary of terms in the data, and representative queries used to interrogate the data, to create a non-technical or natural language description of business value of the table and its columns and data.

### TECHNICAL FIELD

This application relates generally to systems, methods, and apparatuses, including computer program products, for translating and assigning business meaning and value to database metadata.

### BACKGROUND

Large language models (LLMs) can be used to write and interpret structured query language (SQL) code but have not been used to assign business value to SQL code. Reading metadata from tables into a LLM is possible but has the risk that the model will not recognize or correctly interpret words rarely or not present in the training corpora. Examples of issues with current technology include that LLMs such as ChatGPT-3 and -4 can create working code—but cannot consistently write expert code and have not been benchmarked on metadata analysis. Large language models by themselves are also relatively unreliable.

While use of extended chain of thought prompting has been documented, has not been applied to business value interpretation of SQL code. Also, while use of LLMs to interpret or summarize data individual sources has been demonstrated but has not been used in situations integrating multiple sources of information in interpreting business meaning of SQL code.

Additionally, LLMs have been used to document technical works (e.g. java or python code) but are unable to provide the business meaning of the code. While the immense value of collected data has been recognized in many areas of business in recent years and there is a wealth of such data held in databases and SQL code, there has not been any efficient means to readily extract business-specific meanings and value from such information.

### SUMMARY

Systems and methods of the invention provide a new use of a large language model to integrate data from multiple sources including technical metadata (e.g. column and table names) with a dictionary of standard abbreviations employed in the metadata, representative data from the columns rows of the table, a business glossary of terms in the data, and representative queries used to interrogate the data, to create a non-technical description of the business value of the table and its columns and data. This plain, natural language description can be used by business users secking the location of the data and its use to address business and analytic needs.

In various embodiments, a data pipeline can be employed that delivers the following data:
1) From a database metadata repository: a) Table name, type (e.g., table, view, materialized view, etc.) b) Column name, type (e.g. integer, date, varchar);
2) Actual representative data from a) the table, as rows of data, in a format that matches the data to the column (e.g. JSON format) and b) the columns as a list of representative value, and a as extreme values (e.g. earliest date and latest date);
3) An abbreviation data dictionary in structured format with definitions for abbreviations that may be specific to a particular business, business group, or data custodian within the business (e.g. [{‘CTG’: ‘Corporate Technology Group’}, [‘HK’: ‘Hash Key’}]);
4) A business term data dictionary in structured format with definitions for abbreviations relevant to the general field of business associated with the database (e.g. [{‘REIT’: ‘Real Estate Investment Trust’}]);
5) Representative SQL Queries referencing the tables and columns;
6) A large language model (LLM) (which may or may not be “fine-tuned” to learn the abbreviations and data dictionary entries);
7) A prompting module, to provide the necessary prompt prefixes to data and metadata fed to the LLM, to ensure the model follows chain-of-thought reasoning and prevent incorrect responses (hallucinations) by the model.
8) A pipeline module—to feed the information in a specific sequence to the LLM to maximize the accuracy of the business description output by the LLM and
9) A repository (e.g. a database or other application) to store results of the LLM's analysis of the input data, indexed by the table and column being interpreted, along with the output business description, and use cases that identify how the table and columns are used in conjunction with other tables and columns, along with references to the appropriate abbreviations and business glossary entries and relevant data or queries to enable a non-technical user to verify the results.

Aspects of the invention can include a computerized method for translating database metadata. Methods can include providing a large language model (LLM) artificial neural network with: 1) metadata about objects in a database, said objects comprising one or more of schemas, tables, and columns and said metadata comprising one or more of names and attributes of the objects, 2) representative data from the objects in the database, 3) a plurality of representative structured query language (SQL) queries from the database, wherein one or more of the plurality of representative SQL queries have been used to populate one or more of the tables or to retrieve data from one or more of the tables, and 4) a data dictionary provided in structured format and comprising natural language translations for abbreviations used in naming the objects in the database. The LLM can also be provided with a plurality of natural language prompts and then be used to create a database storing a description of the database objects, said descriptions indexed by one or more of the schemas, tables, and columns and comprising: (1) a natural language description of the database tables and columns, (2) a natural language description of one or more use cases describing how the tables and columns relate to other tables and columns. (3) references to entries in the data dictionary used to create the natural language description of the database tables and columns, and (4) relevant data or queries for user verification of the natural language description of the database tables and columns.

Methods can further include providing the schemas, the representative data, the plurality of representative SQL queries, and the data dictionary using a pipeline module in a defined sequence to maximize accuracy of the description. In some embodiments, methods can further comprise providing the schemas, the representative data, the plurality of representative SQL queries, and the data dictionary using a prompting module along with prompt prefixes to data and metadata, wherein the LLM applies chain-of-thought reasoning.

The database tables can comprise financial services data for a financial services company. The data dictionary may include general abbreviations relevant to financial services. In certain embodiments, the data dictionary can include abbreviations specific to the financial services company. The schemas can comprise table dimensions for the database tables to be analyzed. The schemas may comprise a table name for the database tables to be analyzed. The schemas can comprise column dimensions for one or more database columns to be analyzed. The schemas can include a column name for one or more columns in the database table to be analyzed.

In some embodiments, the representative data can comprise rows of data from the database table to be analyzed is presented in a format that matches data in the row to specific columns in the database table to be analyzed. The format may be JavaScript Object Notation (JSON). The representative data can comprise a subset of most frequently occurring values in one or more columns of the database table to be analyzed. The subset can consist of 5 most frequently occurring values in the one or more columns of the database table to be analyzed. The subset can consist of 10 most frequently occurring values in the one or more columns of the database table to be analyzed. The representative data can include statistical range of values in one or more columns of the database table to be analyzed. Statistical ranges may include, for example, one or more of an upper limit, a lower limit, an average, a mean, a median, a first quartile value, and a third quartile value. In various embodiments, the representative SQL queries can reference one or more database tables and one or more columns therein.

In certain aspects, systems of the invention can include a computer system for translating database metadata, the system comprising a processor in communication with a non-transient memory and operable to perform the steps of: providing a large language model (LLM) artificial neural network with: 1) metadata about objects in a database, said objects comprising one or more of schemas, tables, and columns and said metadata comprising one or more of names and attributes of the objects, 2) representative data from the objects in the database, 3) a plurality of representative structured query language (SQL) queries from the database, wherein one or more of the plurality of representative SQL queries have been used to populate one or more of the tables or to retrieve data from one or more of the tables, and 4) a data dictionary provided in structured format and comprising natural language translations for abbreviations used in naming the objects in the database. The LLM can be provided with a plurality of natural language prompts and used to create a database storing a description of the database objects, said descriptions indexed by one or more of the schemas, tables, and columns and comprising: (1) a natural language description of the database tables and columns, (2) a natural language description of one or more use cases describing how the tables and columns relate to other tables and columns. (3) references to entries in the data dictionary used to create the natural language description of the database tables and columns, and (4) relevant data or queries for user verification of the natural language description of the database tables and columns.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for translating database metadata using an LLM.

FIG. 2 shows an exemplary method for translating database metadata using an LLM.

FIG. 3 illustrates data architecture for systems and methods for translation of database metadata.

FIG. 4 illustrates application architecture for systems and methods for translation of database metadata.

### DETAILED DESCRIPTION

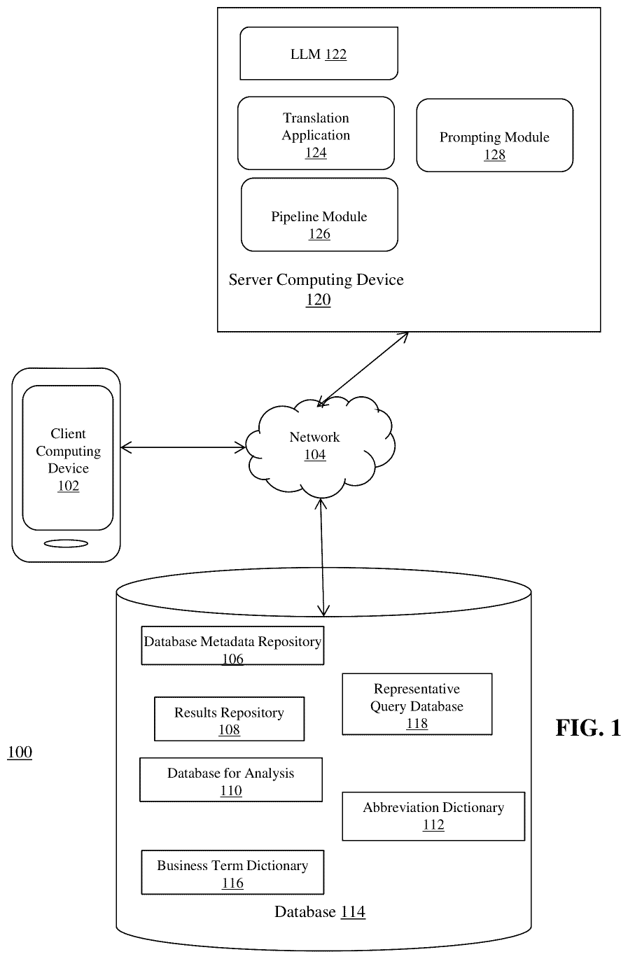

FIG. 1 is a block diagram of an exemplary system 100 for translating database metadata. The system 100 includes a client computing device 102, a communications network 104, a server computing device 120 that includes a large language model 122, a translation module or application 124, a pipeline module 126, and a prompting module 128. The system 100 also includes a database 114 storing a database metadata repository 106, a results repository 108, one or more databases to be analyzed or translated by the application 110, an abbreviation dictionary 112, a business term dictionary 116, and a representative query database 118.

The client computing device 102 connects to one or more communications networks (e.g., network 104) in order to communicate with the server computing device 106 to provide input and receive output relating to database translation. Analysts or other users may interact with the translation module of application 124 via a client computing device 102. For example, a user interface displayed on the client computing device 102 and one or more input/output devices can allow the user to enter queries, request analysis of various databases, and review business value translation results among other actions.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used in conjunction with applications or modules on the server computing device 106. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., enter or approve time worked or request time off). Generally, a browser application comprises software executing on a processor of the client computing device 102 that enables the client computing device to communicate via HTTP or HTTPS with remote servers addressable with URLs (e.g., server computing device 106) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 106 and the database 114 in certain embodiments. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 120 is a device including specialized hardware and/or software modules that execute on a processor and interact with memory modules of the server computing device 120, to receive data from other components of the system 100, transmit data to other components of the system 100, and perform functions (e.g., time entry, scheduling, and payroll management as discussed above). As discussed above the server computing device 120 includes the LLM 122, the translation application or module 124, the pipeline module 126, and the prompting module 128 along with any number of other programs that may execute on the processor of the server computing device 120 and may each, despite being disparate programs, rely on a regular exchange of data between them and/or the database 114. In some embodiments, the various modules, programs, or applications are specialized sets of computer software instructions programmed onto one or more dedicated processors in the server computing device 120 and can include specifically designated memory locations and/or registers for executing the specialized computer software instructions.

Although the applications and modules are shown in FIG. 1 as executing within the same server computing device 120, in some embodiments the functionality of the applications and modules can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the applications, programs, and/or modules is described in detail throughout this specification.

The database 114 is a computing device (or in some embodiments, a set of computing devices) coupled to the server computing device 120 and is configured to receive, generate, and store specific segments of data relating to business meaning translation of database metadata. In some embodiments, all or a portion of the database 114 can be integrated with the server computing device 120 or be located on a separate computing device or devices. The database 114 can comprise one or more databases configured to store portions of data used by the other components of the system 100, as will be described in greater detail below.

In some embodiments, the database 114 comprises a database metadata repository 106 storing information relating to databases to be analyzed including table and column names and types. The database 114 can also include a results repository 108 wherein the business value meaning and other translation data resulting from the translation application can be stored. In various embodiments, those results can include one or more of a natural language description of the database tables and columns; a natural language description of one or more use cases describing how the tables and columns relate to other tables and columns; references to entries in the data dictionary used to create the natural language description of the database tables and columns; and relevant data or queries for user verification of the natural language description of the database tables and columns.

The database 114 can include one or more databases 110 that the translation module or application 124 operate to analyze and translate. A business term dictionary 116, representative query database 118, and abbreviation dictionary 112 can also be included 114 for use in the translation process as described herein.

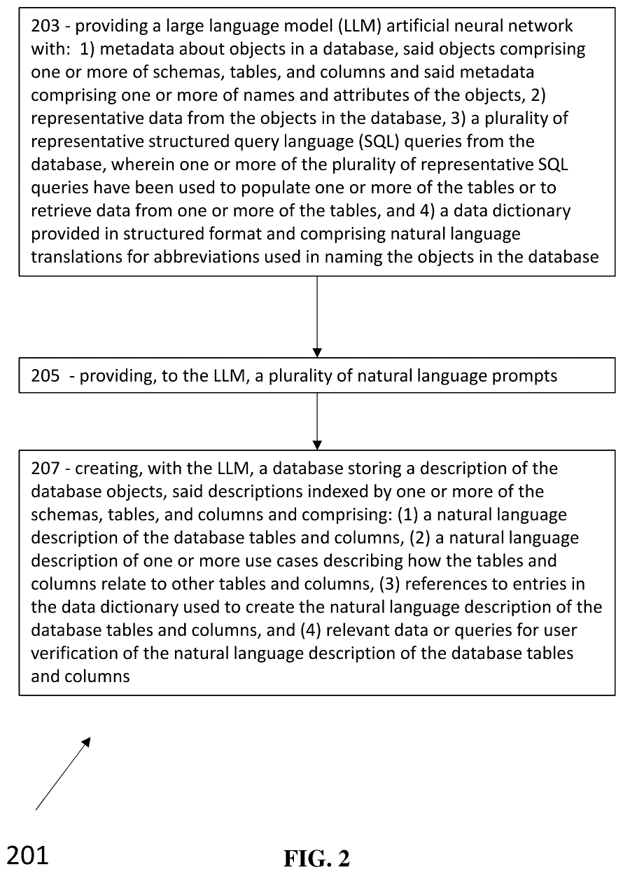

FIG. 2 shows an exemplary method 201 for translating database metadata. The method 201 can include providing 203 a large language model (LLM) artificial neural network with: 1) metadata about objects in a database, said objects comprising one or more of schemas, tables, and columns and said metadata comprising one or more of names and attributes of the objects, 2) representative data from the objects in the database. 3) a plurality of representative structured query language (SQL) queries from the database, wherein one or more of the plurality of representative SQL queries have been used to populate one or more of the tables or to retrieve data from one or more of the tables, and 4) a data dictionary provided in structured format and comprising natural language translations for abbreviations used in naming the objects in the database. A plurality of natural language prompts can be provided 205 to the LLM. The LLM can then be used to create 207 a database storing a description of the database objects, said descriptions indexed by one or more of the schemas, tables, and columns and comprising: (1) a natural language description of the database tables and columns, (2) a natural language description of one or more use cases describing how the tables and columns relate to other tables and columns. (3) references to entries in the data dictionary used to create the natural language description of the database tables and columns, and (4) relevant data or queries for user verification of the natural language description of the database tables and columns. Systems and methods of the invention may use any known LLM or suite of LLMs including, for example, Pythia available from EleutherAI.

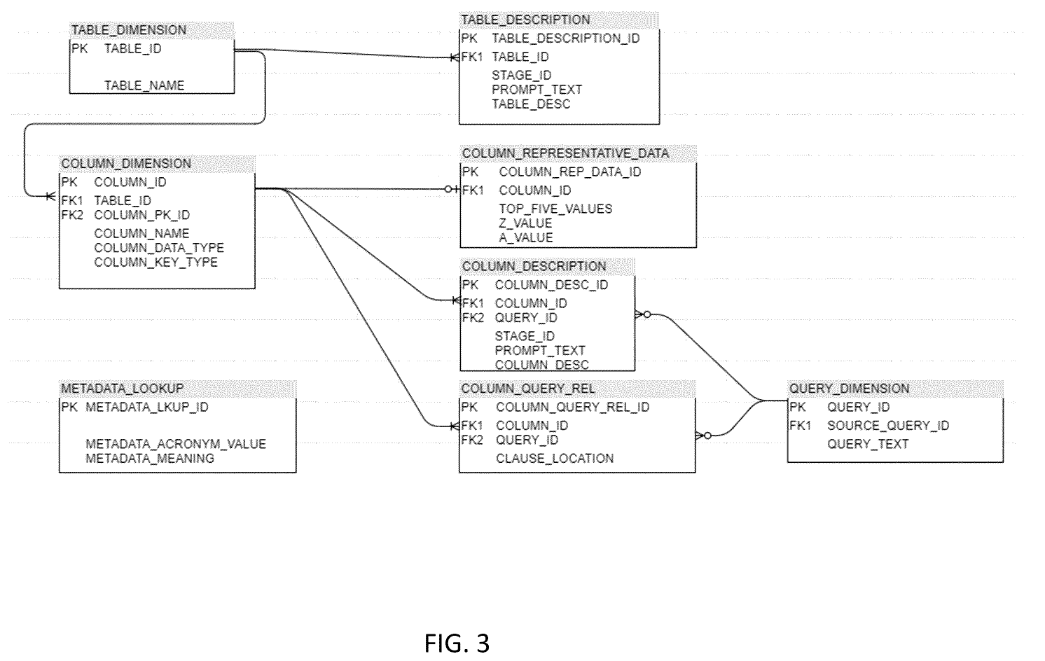

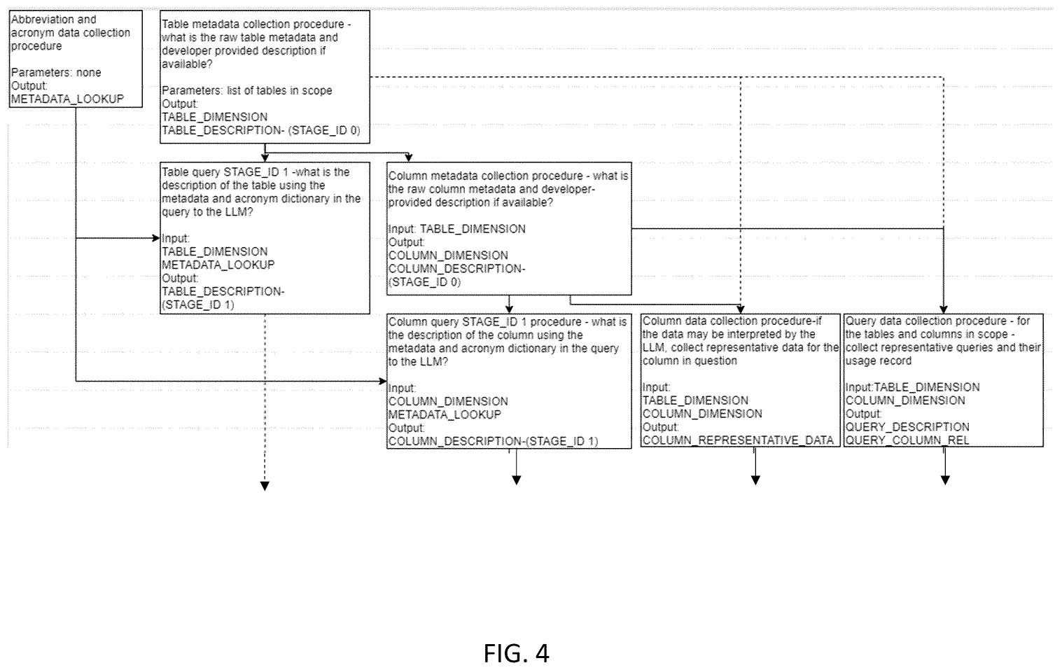

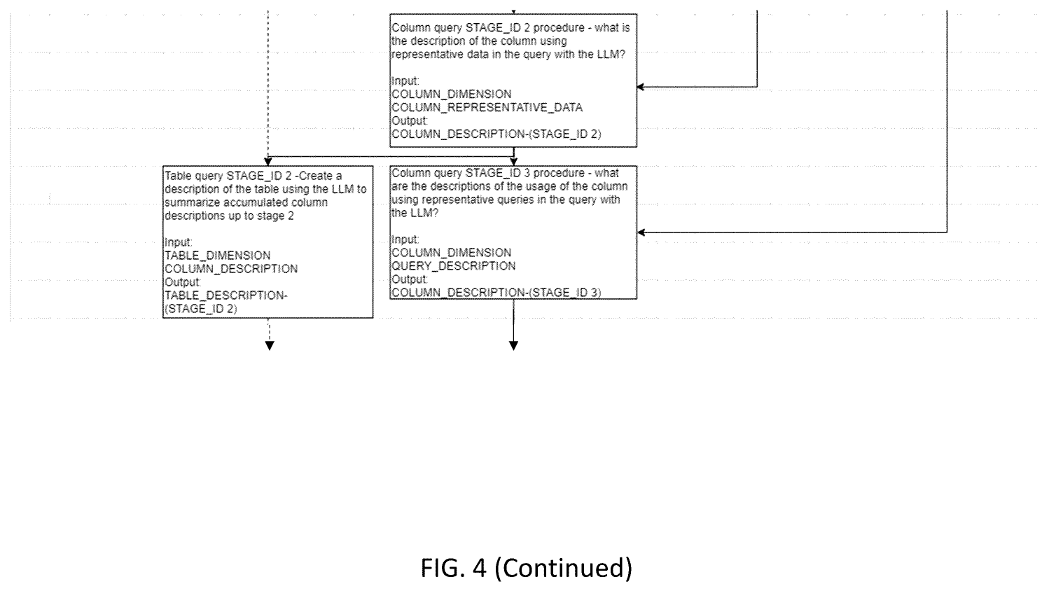

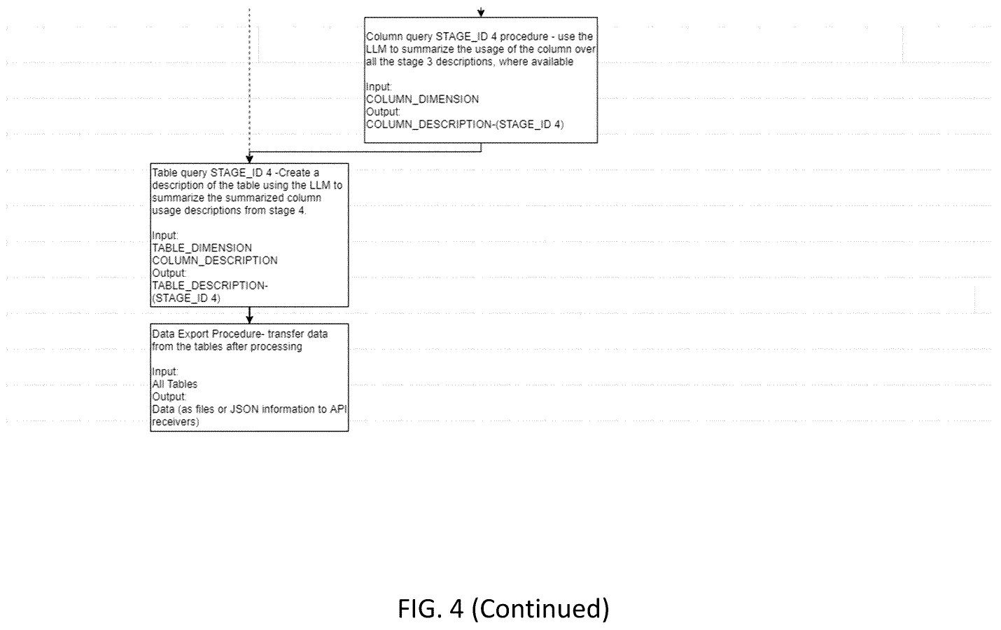

In certain embodiments, the systems and methods of the invention can use architectures such as those described in FIGS. 3 and 4. The architecture summarized herein can include a Data Architecture-references to tables for storing input data, intermediate steps in processing, and the output of the logic as well as the output of a Large Language Model (hereafter LLM). Data Architecture is presented here in the form of an entity relationship diagram with crows-foot notation to show the relationship between key columns in the tables.

The logic of the process can be summarized in the Application Architecture as a set of procedures that present the input data and intermediate steps in the process to one or more LLMs. The procedures are summarized in the figures as boxes connected by arrows to designate precedence dependencies, and positioned on the page to indicate sequence of operation. Boxes the same distance from the top of the picture may run in parallel.

FIG. 3 illustrates data architecture for systems and methods for translation of database metadata. Tables shown in FIG. 3 can be used for the collection of data needed by the process, and data needed for the storage of the results of processing. Standard columns for auditing (e.g. transaction timestamp) are not shown in this depiction.

There are five tables for input of external data: the table dimension (TABLE_DIMENSION), the column dimension (COLUMN_DIMENSION), column representative data (COLUMN_REPRESENTATIVE_DATA), and the query dimension (QUERY_DIMENSION) are from the system in scope for analysis, and contain the table metadata, column metadata, column data, and query data in scope for interpretation by the large language model.

The fifth table (METADATA_LOOKUP) input with external data contains the approved metadata values and their meaning. In preferred embodiments, the system can define suffixes, infixes, and prefixes for column name, for instance, Leszynski Naming Convention, which can be augmented with abbreviations or acronyms that are specific to the context of the organization implementing the database architecture.

There can be a hierarchical relationship between tables and their columns, meaning that each column is indexed by a reference to its table. Representative data from a column can also indexed by column. In some embodiments, there may be a many-to-many relationship between columns and queries, meaning that one query may reference many columns, from many tables potentially, and a column may be referenced in many queries, which is tracked by a relationship table (COLUMN_QUERY_REL).

Column descriptions created by the processing steps shown can be recorded at four stages in the COLUMN_DESCRIPTION table. On loading the column metadata, if there is a description attached, it can be stored as stage zero. Where the column name can be interpreted (using metadata lookups or not), the resulting description created by an LLM can be stored as stage 1. Where a column's representative data can be interpreted by the LLM, it can be stored as stage 2. Each query that references the column can be interrogated by the LLM to describe the use of the column in that query and that information can be stored as stage 3, indexed also by the query. The LLM can be asked to summarize the uses of the column by queries to create a final summary, stored as stage 4.

Table descriptions created by processing may be stored at three stages in the TABLE_DESCRIPTION table. On loading the table metadata, where there is a description attached, it can be stored as stage zero. Where the column name can be interpreted (using metadata lookups or not), the resulting description created by an LLM can be stored as stage 1. Where the column descriptions are present at stage 0, 1, or 2, they may be summarized by the LLM to provide a table description at stage 2. After the uses of the columns for the table in queries are summarized to stage 4, they can be summarized by the LLM to give a description of the uses of the table in queries at stage 4.

FIG. 4 illustrates application architecture for systems and methods for translation of database metadata. The application architecture starts with the collection of metadata lookups and metadata of tables requested by the user of the application. Since there is a relationship between tables and columns, the lookup of column metadata information can be collected after the table information and the column's data can be collected after determining from the metadata that the data in the column can be interpreted by an LLM to provide a useful description of the column's purpose. The query data can also be collected after the column metadata, to ensure the query can be stored with proper reference in the COLUMN_QUERY_REL table.

As noted above, Tables and Columns may be augmented with descriptions present in their metadata, which may be collected in the table description and column description tables as stage 0. Each table name and column name can be processed by reference to the metadata lookup, which can be used to prompt the LLM for a full description of the table or column in separate procedures as the stage 1 description.

If the column data can be used, it can be collected and then presented to the LLM to elicit a description of the column contents, recorded as the stage 2 description of the column. For each table with columns with stage 2 descriptions, the LLM may be used to summarize the column data descriptions to create the stage 2 description of the table.

The queries that use the columns can be processed in the third stage, to produce stage 3 descriptions of the columns, one for each query. Insofar as a column might be used in different ways in different queries (e.g., present in the select clause for output or present in a group by statement for reporting aggregates), these may also need to be summarized by the LLM to provide a cogent, simple description of the use of the column in queries as a single stage 4 description.

A final use of the LLM can be to summarize the stage 4 descriptions of the columns in a table to provide a description of the table's use in queries as a stage 4 description of the table.

While the descriptions at each stage can be accessed by appropriate reporting tools, a procedure may be included to export the descriptions as files or in JSON format for API access by other tools.

In various embodiments, business meaning and value description of technology metadata may be automatically processed. The business meaning of technology assets is difficult to determine from the names and the language used. For databases, table and column names often use abbreviations or jargon that don't translate directly into the business meaning of the data. This means a business user, provided a large number of tables and columns with incomprehensible names (to the user) faces a barrier to accessing the right data and using it correctly.

In various embodiments, systems and methods of the invention can translate database metadata into natural language descriptors including business value of the database metadata using the following components:

a data pipeline that delivers the following data:
1) From a database metadata repository:
   a) Table name, type (e.g., table, view, materialized view, etc.)
   b) Column name, type (e.g. integer, date, varchar)
2) Actual representative data from:
   a) the table, as rows of data, in a format that matches the data to the column (e.g. JSON format); and
   b) the columns as a list of representative value, and a as extreme values (e.g. earliest date and latest date).
3) An abbreviation Data dictionary in structured format: (e.g. [{‘CTG’: ‘Corporate Technology Group’}, [‘HK’: ‘Hash Key’}])
4) A business term data dictionary in structured format (e.g. [{‘REIT’: ‘Real Estate Investment Trust’}].
5) Representative SQL Queries using the tables and columns.
6) A large language model (LLM) (which may or may not be “fine-tuned” to learn the abbreviations and data dictionary entries).
7) A prompting module, to provide the necessary prompt prefixes to data and metadata fed to the LLM, to ensure the model follows chain-of thought reasoning and prevent incorrect responses (hallucinations) by the model.
8) A pipeline module—to feed the information in a sequence to the LLM to maximize the accuracy of the business description output by the LLM.
9) A results repository (e.g. a database or other application) to store the result of the LLM's analysis of the input data, indexed by the table and column being interpreted, along with the output business description, and use cases that identify how the table and columns are used in conjunction with other tables and columns, along with references to the appropriate abbreviations and business glossary entries, relevant data or query to enable a non-technical user to verify the results.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

### EXAMPLES

### Example 1—Database Metadata Interpretation Using, for Example, Pythia LLM

Prompt: CTG refers to the Fidelity Corporate Technology Group, and ITEC is the old abbreviation for the Product Area now known as CAEC, and TMDL stands for the Technology Management Data Lake

Query: please explain the meaning of the database name ‘CTG_ITEC_TMDL_PRD

LLM response: CTG_ITEC_TMDL_PRD is a database name used by the Fidelity Corporate Technology Group at Fidelity Investments. The database contains information about the IT systems and processes used by the company, including the technologies used, their performance, and any issues or problems that may arise. The database is used to manage the IT infrastructure and ensure that it is functioning properly, and is used to help Fidelity identify areas for improvement and make data-driven decisions to optimize the company's IT operations.

### Example 2—Demonstration of Column Description with Data

Prompt: CTG refers to the Fidelity Corporate Technology Group, and ITEC is the old abbreviation for the Product Area now known as CAEC, and TMDL stands for the Technology Management Data Lake

Query: please explain the meaning of the column name ‘ENVIRONMENT_NAME’, which has as its top five values ‘ALL’, ‘PRD’, ‘DEV’, ‘QA’ and ‘SND’, which is a column in the table named ‘CLOUD_CPU_UTILIZATION_MONTHLY’, which is in the schema TMDL_CLOUDCOST_CURATED_C that is within database CTG_ITEC_TMDL_PRD

LLM response: The ENVIRONMENT_NAME column in the Cloud CPU Utilization Monthly table in the TMDL_CLOUDCOST_CURATED_C schema of the CTG_ITEC_TMDL_PRD database represents the environment name of the data. The top five values in the ENVIRONMENT_NAME column are ‘ALL’, ‘PRD’, ‘DEV’, ‘QA’, and ‘SND’, which correspond to the different environments in which the data was collected. The ENVIRONMENT_NAME column is used to distinguish between different environments and to ensure that the data is properly aligned with the relevant environments. For example, if the data was collected in a production environment, the ENVIRONMENT_NAME column would contain the value ‘PRD’, while if the data was collected in a development environment, the ENVIRONMENT_NAME column would contain the value ‘DEV’.

What is claimed is:

1. A computerized method for translating database metadata, the method comprising:
providing a large language model (LLM) artificial neural network with:
1) metadata about objects in a database, said objects comprising one or more of schemas, tables, and columns and said metadata comprising one or more of names and attributes of the objects,
2) representative data from the objects in the database,
3) a plurality of representative structured query language (SQL) queries from the database, wherein one or more of the plurality of representative SQL queries have been used to populate one or more of the tables or to retrieve data from one or more of the tables, and
4) a data dictionary provided in structured format and comprising natural language translations for abbreviations used in naming the objects in the database;
providing, to the LLM, a plurality of natural language prompts; and
creating, with the LLM, a database storing a description of the database objects, said descriptions indexed by one or more of the schemas, tables, and columns and comprising:
(1) a natural language description of the database tables and columns,
(2) a natural language description of one or more use cases describing how the tables and columns relate to other tables and columns,
(3) references to entries in the data dictionary used to create the natural language description of the database tables and columns, and
(4) relevant data or queries for user verification of the natural language description of the database tables and columns.

2. The computerized method of claim 1, further comprising providing the schemas, the representative data, the plurality of representative SQL queries, and the data dictionary using a pipeline module in a defined sequence to maximize accuracy of the description.

3. The computerized method of claim 1, further comprising providing the schemas, the representative data, the plurality of representative SQL queries, and the data dictionary using a prompting module along with prompt prefixes to data and metadata, wherein the LLM applies chain-of-thought reasoning.

4. The computerized method of claim 1, wherein the database tables comprise financial services data for a financial services company.

5. The computerized method of claim 4, wherein the data dictionary comprises general abbreviations relevant to financial services.

6. The computerized method of claim 4, wherein the data dictionary comprises abbreviations specific to the financial services company.

7. The computerized method of claim 1, wherein the schemas comprise table dimensions for the database tables to be analyzed.

8. The computerized method of claim 1, wherein the schemas comprise a table name for the database tables to be analyzed.

9. The computerized method of claim 1, wherein the schemas comprise column dimensions for one or more database columns to be analyzed.

10. The computerized method of claim 1, wherein the schemas comprise a column name for one or more columns in the database table to be analyzed.

11. The computerized method of claim 1, wherein the representative data comprises rows of data from the database table to be analyzed is presented in a format that matches data in the row to specific columns in the database table to be analyzed.

12. The computerized method of claim 11, wherein the format is JavaScript Object Notation (JSON).

13. The computerized method of claim 1, wherein the representative data comprises a subset of most frequently occurring values in one or more columns of the database table to be analyzed.

14. The computerized method of claim 13, wherein the subset consists of 5 most frequently occurring values in the one or more columns of the database table to be analyzed.

15. The computerized method of claim 13, wherein the representative data comprises a statistical range of values in one or more columns of the database table to be analyzed.

16. The computerized method of claim 13, wherein the representative SQL queries reference one or more database tables and one or more columns therein.

17. A computer system for translating structured query language (SQL) database metadata, the system comprising a processor in communication with a non-transient memory and operable to perform the steps of:
providing a large language model (LLM) artificial neural network with:
1) metadata about objects in a database, said objects comprising one or more of schemas, tables, and columns and said metadata comprising one or more of names and attributes of the objects,
2) representative data from the objects in the database,
3) a plurality of representative structured query language (SQL) queries from the database, wherein one or more of the plurality of representative SQL queries have been used to populate one or more of the tables or to retrieve data from one or more of the tables, and
4) a data dictionary provided in structured format and comprising natural language translations for abbreviations used in naming the objects in the database;
providing, to the LLM, a plurality of natural language prompts; and
creating, with the LLM, a database storing a description of the database objects, said descriptions indexed by one or more of the schemas, tables, and columns and comprising:
(1) a natural language description of the database tables and columns,
(2) a natural language description of one or more use cases describing how the tables and columns relate to other tables and columns,
(3) references to entries in the data dictionary used to create the natural language description of the database tables and columns, and
(4) relevant data or queries for user verification of the natural language description of the database tables and columns.

18. The computer system of claim 17, further operable to provide the schemas, the representative data, the plurality of representative SQL queries, and the data dictionary using a pipeline module in a defined sequence to maximize accuracy of the description.

19. The computer system of claim 17, further operable to provide the schemas, the representative data, the plurality of representative SQL queries, and the data dictionary using a prompting module along with prompt prefixes to data and metadata, wherein the LLM applies chain-of-thought reasoning.

20. The computerized system of claim 17, wherein the schemas comprise table dimensions and a table name for the database table to be analyzed and column dimensions and a column name for one or more columns in the database table to be analyzed.
